(19) United States
(12) Patent Application Publication
(10) Pub. No.: US 2008/0043852 A1
(43) Pub. Date: Feb. 21, 2008

(54) Deblocking filtering methods and image processing devices using the deblocking filtering

(75) Inventors: Jae-sung Park, Suwon-si (KR); Yue Li, Suwon-si (KR); Doo-hyun Kim, Seoul (KR); Irina Kim, Suwon-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD

(21) Appl. No.: 11/806,588

(22) Filed: Jun. 1, 2007

(30) Foreign Application Priority Data
Aug. 17, 2006 (KR) 10-2006-0077809

(51) Int. Cl. H04N 7/26

(52) U.S. Cl. 375/240.27; 375/E07.241

(57) ABSTRACT

A deblocking filtering method may includes setting first through n^{th} macroblock groups which are adjacent to one another in a column direction and sequentially performing deblocking filtering on the first through n^{th} macroblock groups. Each macroblock group may include at least one macroblock. An image processing device may include a deblocking filter that performs deblocking filtering in macroblock units; and a control unit that sets first through n^{th} macroblock groups, which are adjacent to one another in a column direction, and that controls the deblocking filter to sequentially perform deblocking filtering on the first through n^{th} macroblock groups. Once again, each macroblock group may include at least one macroblock.

### PRIORITY STATEMENT

This application claims priority from Korean Patent Application No. 10-2006-0077809, filed on Aug. 17, 2006, in the Korean Intellectual Property Office (KIPO), the entire contents of which are incorporated herein by reference.

### BACKGROUND

1. Field

Example embodiments relate to image processing. Also, example embodiments relate to deblocking filtering methods and image processing devices using the deblocking filtering methods.

2. Description of Related Art

There are multimedia data compression techniques such as H.261 and H.263, that are established by the International Telecommunication Union-Telecommunication (ITU-T) Standardization Section for moving picture service in wired/wireless communication network environments, and Moving Picture Experts Group (MPEG)-1, MPEG-2, and MPEG-4, that are established by the International Organization for Standardization (ISO). With the wide spread of wireless communication and the demand for higher-efficiency video compression technology than existing compression technology, H.264 (MPEG-4 Part 10 AVC) has been established as a standard video compression codec.

H.264 is a next-generation video compression standard jointly established by the ITU-T and the ISO. H.264 can easily adapt to various network environments and has made remarkable progress in terms of video coding efficiency when compared to MPEG. In other words, H.264 allows for improved motion estimation and compensation, and also includes a deblocking filter. Moreover, in H.264, small block-size transformation having no mismatch and improved entropy coding are available.

According to the video compression standards described above, encoding and decoding are performed on a digital image in block units. Currently, a digital image reproduced after being decoded often has boundary discontinuities between adjacent blocks. This phenomenon is referred to as blocking artifacts. Deblocking filters may be used to reduce or remove the blocking artifacts. One type of deblocking filter is an adaptive filter that performs relatively weaker filtering on areas having many edges in order to preserve edge information and performs relatively stronger filtering on simpler areas to remove the blocking artifacts. The display quality of the filtered image is improved by about 5-10% when compared to a non-filtered image.

FIG. 1 illustrates a frame divided into macroblocks to explain conventional deblocking filtering.

A single frame is generally divided into macroblocks of 16×16 pixels. In FIG. 1, it is assumed that 12 macroblocks (a, b, c, . . . , k, and 1) constitute a single frame 100. Referring to FIG. 1, in order to perform deblocking filtering on a macroblock f, a reference area e″ of a neighbor macroblock e, located to the left side of the macroblock f, and a reference area b′ of a neighbor macroblock b, located above the macroblock f, should be referred to.

According to conventional deblocking filtering, a deblocking filter performs deblocking filtering using a raster scan method. For example, when the frame 100 of FIG. 1 is deblocking-filtered, deblocking filtering starts from the macroblock a and continues in the order of b, then c, then d (e.g., in the row direction). When deblocking filtering on the macroblock d is completed, deblocking filtering is resumed in the macroblock e and continues in the order of f, then g, then h. When deblocking filtering is resumed in the macroblock e and continues in the row direction, a reference area located to the left side of a macroblock to be deblocking-filtered and reference areas a′, b′, c′, and d′ located above the macroblocks e through h are stored in an internal memory. When deblocking is resumed in the macroblock i and continues in the row direction, a reference area located to the left side of a macroblock to be deblocking-filtered and reference areas e′, f′, g′, and h′ located above the macroblocks i through 1 are stored in the internal memory.

Thus, the internal memory should have a memory capacity that is at least equal to a sum of the size of a reference area located to the left side of a macroblock to be deblocking-filtered and the size of reference areas for the macroblock row located above the macroblock to be deblocking-filtered. As a result, the internal memory requires a large memory capacity. Moreover, in this case, macroblocks to be deblocking-filtered should be stored in the internal memory one-by-one, increasing the bandwidth required to access an external memory that stores the respective frame.

### SUMMARY

Example embodiments provide deblocking filtering methods that may reduce internal memory capacity requirements and that may reduce bandwidth required to access external memory.

Example embodiments also provide image processing devices that may use the deblocking filtering methods.

According to an example embodiment, a deblocking filtering method may include setting first through n^{th} macroblock groups that are adjacent to one another in a column direction; and sequentially performing deblocking filtering on the first through n^{th} macroblock groups. Each macroblock group may include at least one macroblock.

The deblocking filtering method may include storing a macroblock group to be deblocking-filtered in internal memory.

The deblocking filtering method may include, when deblocking filtering of a (k+1)^{th} macroblock group is completed, storing the deblocking-filtered (k+1)^{th} macroblock group and a reference area or areas of the k^{th} macroblock group referred to for the deblocking filtering of the (k+1)^{th} macroblock group in external memory. The value k is a natural number that may be greater than or equal to 1 and less than or equal to (n−1).

The deblocking filtering method may include, when deblocking filtering on the first macroblock group is completed, storing the deblocking-filtered first macroblock group in external memory.

The sequentially performing deblocking filtering on the first through n^{th} macroblock groups may include, when deblocking filtering on the n^{th} macroblock group is completed, performing deblocking filtering on a macroblock group which is adjacent to the first macroblock group in a row direction.

The deblocking filtering method may include, when deblocking filtering on the n^{th} macroblock group is completed, eliminating all or substantially all data stored in the internal memory to initialize the internal memory.

According to another example embodiment, a deblocking filtering method may include setting first through n^{th} macroblock groups which are adjacent to one another in a column direction; storing a macroblock group to be deblocking-filtered in internal memory; sequentially performing deblocking filtering on the first through n^{th} macroblock groups; and storing the deblocking-filtered macroblock group in external memory. When deblocking filtering is to be performed on a (k+1)^{th} macroblock group after deblocking filtering is performed on a k^{th} macroblock group, the internal memory may have a capacity that is greater than or equal to a sum of the size of the (k+1)^{th} macroblock group and the size of a reference area or areas of the k^{th} macroblock group to be referred to for deblocking filtering of the (k+1)^{th} macroblock group. The value k is a natural number that may be greater than or equal to 1 and less than or equal to (n−1).

According to yet another example embodiment, an image processing device may include a deblocking filter that performs deblocking filtering in macroblock units; and a control unit that sets first through n^{th} macroblock groups, which are adjacent to one another in a column direction, and that controls the deblocking filter to sequentially perform deblocking filtering on the first through n^{th} macroblock groups. Each macroblock group may include at least one macroblock.

The image processing device may include an internal memory storing a macroblock group to be deblocking-filtered.

When deblocking filtering is to be performed on a (k+1)^{th} macroblock group after deblocking filtering is performed on a k^{th} macroblock group, the internal memory may have a capacity that is greater than or equal to a sum of the size of the (k+1)^{th} macroblock group and the size of a reference area or areas of the k^{th} macroblock group to be referred to for deblocking filtering of the (k+1)^{th} macroblock group. The value k is a natural number that may be greater than or equal to 1 and less than or equal to (n−1).

The image processing device may include an external memory, wherein when deblocking filtering of a (k+1)^{th} macroblock group is completed, the external memory may store the deblocking-filtered (k+1)^{th} macroblock group and a reference area or areas of a k^{th} macroblock group referred to for the deblocking filtering of the (k+1)^{th} macroblock group. The value k is a natural number that may be greater than or equal to 1 and less than or equal to (n−1).

When deblocking filtering on the n^{th} macroblock group is completed, the control unit may control the deblocking filter to perform deblocking filtering on a macroblock group which is adjacent to the first macroblock group in a row direction.

According to still another example embodiment, an image processing device may include a deblocking filter that performs deblocking filtering in macroblock units; a control unit that sets first through n^{th} macroblock groups, which are adjacent to one another in a column direction and that controls the deblocking filter to sequentially perform deblocking filtering on the first through n^{th} macroblock groups; an internal memory storing a macroblock group to be deblocking-filtered; and an external memory storing the deblocking-filtered macroblock group. Each macroblock group may include at least one macroblock. When deblocking filtering is to be performed on a (k+1)^{th} macroblock group after deblocking filtering is performed on a k^{th} macroblock group, the internal memory may have a capacity that is greater than or equal to a sum of the size of the (k+1)^{th} macroblock group and the size of a reference area or areas of the k^{th} macroblock group to be referred to for deblocking filtering of the (k+1)^{th} macroblock group. The value k is a natural number that may be greater than or equal to 1 and less than or equal to (n−1).

### BRIEF DESCRIPTION OF THE DRAWINGS

The above and/or other aspects and advantages will become more apparent and more readily appreciated from the following detailed description of example embodiments taken in conjunction with the accompanying drawings, in which:

FIG. 1 illustrates a frame divided into macroblocks to explain conventional deblocking filtering;

FIG. 2 is a block diagram of an image processing device according to an example embodiment;

FIG. 3 illustrates the structure of an internal memory illustrated in FIG. 2;

FIG. 4 illustrates a state in which the image processing device illustrated in FIG. 2 performs deblocking filtering on a frame in macroblock group units;

FIG. 5 is a flowchart illustrating a deblocking filtering method according to an example embodiment;

FIG. 6 illustrates the structures of a second macroblock group illustrated in FIG. 4 and reference areas referred to for deblocking filtering of the second macroblock group; and

FIGS. 7A and 7B illustrate areas of macroblocks stored in the internal memory.

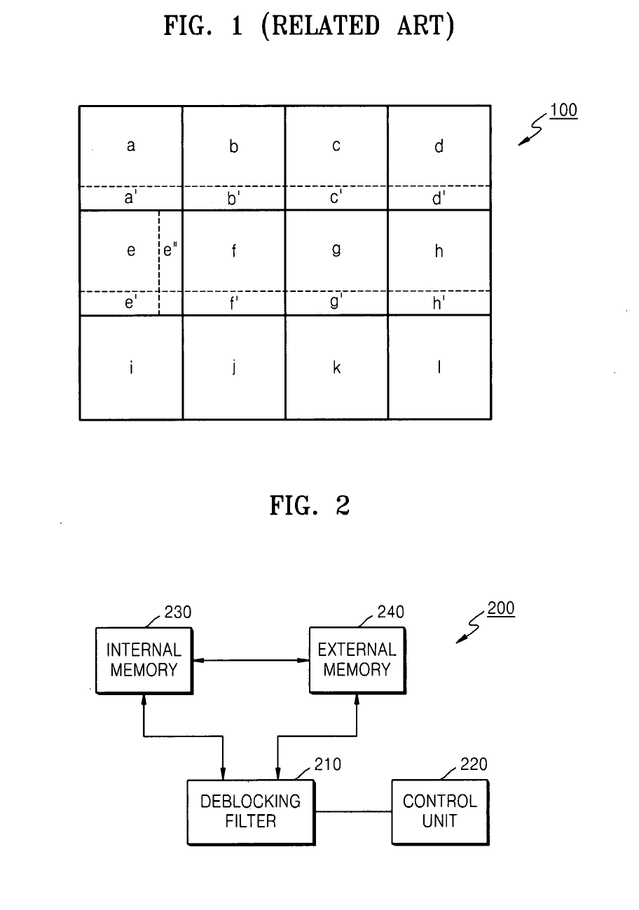

### DETAILED DESCRIPTION OF EXAMPLE EMBODIMENTS

Example embodiments will now be described more fully with reference to the accompanying drawings. Embodiments, however, may be embodied in many different forms and should not be construed as being limited to the example embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” or “coupled to” to another component, it may be directly on, connected to, or coupled to the other component or intervening components may be present. In contrast, when a component is referred to as being “directly on,” “directly connected to,” or “directly coupled to” another component, there are no intervening components present. As used herein, the term “and/or” includes any and all combinations of one or more of the associated listed items.

It will be understood that, although the terms first, second, third, etc., may be used herein to describe various elements, components, regions, layers, and/or sections, these elements, components, regions, layers, and/or sections should not be limited by these terms. These terms are only used to distinguish one element component, region, layer, and/or section from another element, component, region, layer, and/or section. For example, a first element, component, region, layer, and/or section could be termed a second element, component, region, layer, and/or section without departing from the teachings of the example embodiments.

Spatially relative terms, such as “beneath,” “below,” “lower,” “above,” “upper,” and the like may be used herein for ease of description to describe one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

FIG. 2 is a block diagram of an image processing device 200 according to an example embodiment.

Referring to FIG. 2, the image processing device 200 may include deblocking filter 210, control unit 220, internal memory 230, and/or external memory 240.

The deblocking filter 210 may perform deblocking filtering in macroblock units. Generally, a single frame may be divided into macroblocks of 16×16 pixels and/or each of the macroblocks may be divided into sub-blocks of 4×4 pixels. The deblocking filter 210 according to example embodiments may set a macroblock group for at least one of the macroblocks and/or may sequentially perform deblocking filtering on the set macroblock groups. The control unit 220 may control the operation of the deblocking filter 210. The internal memory 230 may store the macroblock groups to be deblocking-filtered by the deblocking filter 210. The deblocking-filtered macroblock groups may be stored in the external memory 240.

The deblocking filter 210 may refer to a reference area or areas for deblocking filtering. For example, it may be assumed that there is a first macroblock group, that is deblocking-filtered, and a second macroblock group, that may be adjacent to the first macroblock group in the column direction and is to be deblocking-filtered. The deblocking filter 210 may refer, for example, to a reference area of the first macroblock group in order to perform deblocking filtering on the second macroblock group. The reference area may be defined by a specific block of a previously deblocking-filtered macroblock group referred to for deblocking filtering.

After the current macroblock group is deblocking-filtered, the external memory 240 may store the deblocking-filtered macroblock group and the reference area.

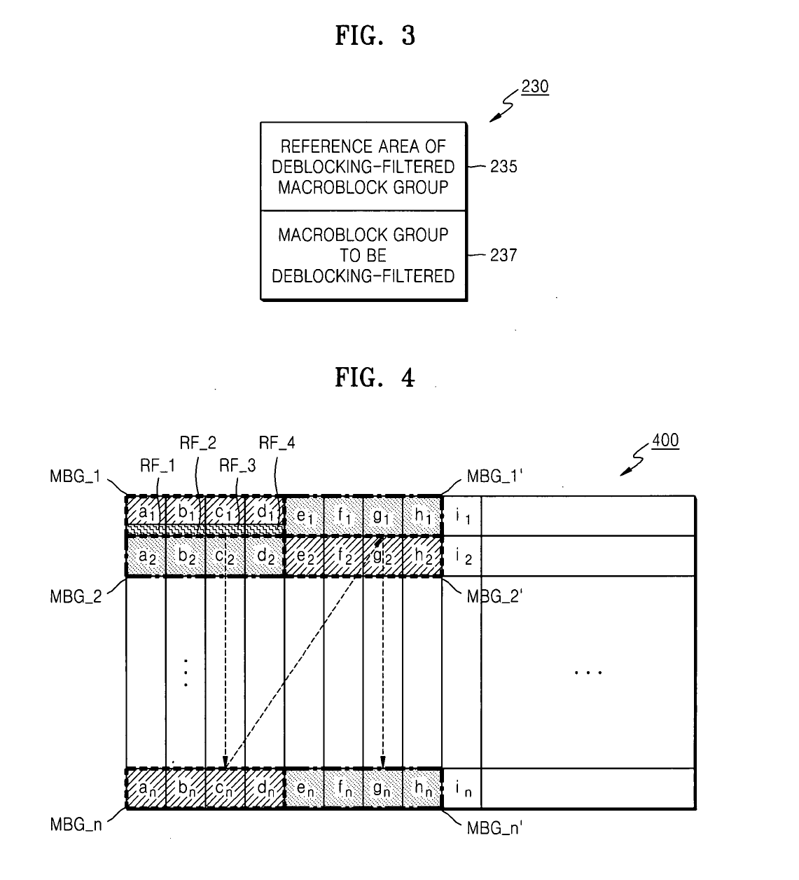

FIG. 3 illustrates the structure of the internal memory 230 illustrated in FIG. 2.

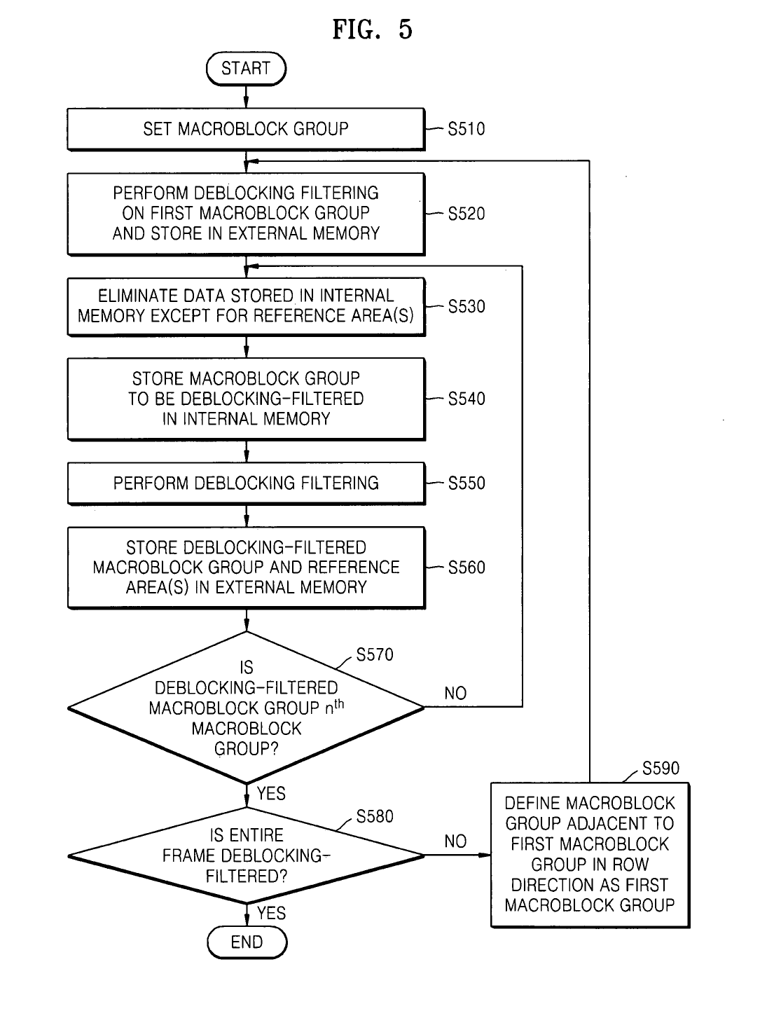

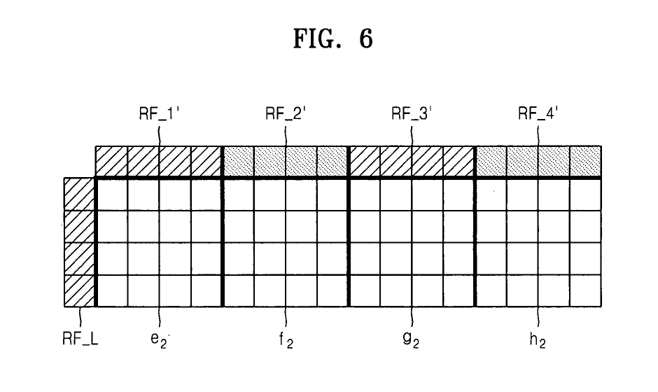

Referring to FIGS. 2 and 3, the internal memory 230 may store a reference area 235 of the deblocking-filtered macroblock group and/or a macroblock group 237 to be deblocking-filtered. One way in which the reference area 235 of the deblocking-filtered macroblock and/or the macroblock group 237 to be deblocking-filtered may be stored in the internal memory 230 as deblocking filtering progresses will be described in detail with reference to FIGS. 5 and 6.

FIG. 4 illustrates a state in which the image processing device 200 illustrated in FIG. 2 performs deblocking filtering on a frame in macroblock group units.

Referring to FIG. 4, blocks a₁, b₁, c₁, . . . , a₂, b₂, c₂, . . . , aₙ, bₙ, cₙ, . . . represent macroblocks and every four macroblocks, for example, may be set as macroblock groups MBG_1, MBG_2, . . . , MBG_n, MBG_1′, MBG_2′, . . . , MBG_n′, . . . . The number of macroblocks to be included in a macroblock group may be set as desired. Blocks RF_1, RF_2, RF_3 and RF_4 represent reference areas.

Let a macroblock group that may include the macroblocks a₁, b₁, c₁, and d₁ be a first macroblock group MBG_1 and a macroblock group that may include macroblocks a₂, b₂, c₂, and d₂ be a second macroblock group MBG_2. In FIG. 4, macroblock groups adjacent to one another in the column direction may be defined as first through n^{th} macroblock groups MBG_1, MGB_2, . . . , MBG_n.

Once the macroblocks are grouped into the macroblock groups, deblocking filtering may start from the first macroblock group MBG_1 in the column direction. In other words, after deblocking filtering is performed on the first macroblock group MBG_1, it may be performed on the second macroblock group MBG_2. In this way, when deblocking filtering on the n^{th} macroblock group MBG_n is completed, a macroblock group that may be adjacent to the first macroblock group MBG_1 in the row direction (e.g., a macroblock group that may include macroblocks e₁, f₁, g₁, and h₁), may be defined as a first macroblock group MBG_1′ and deblocking filtering may be resumed in the first macroblock group MBG_1′ in a manner similar to that described above. Thus, deblocking filtering on the entire frame 400 may be completed by performing deblocking filtering on macroblock groups included in the frame 400 in the column direction.

FIG. 5 is a flowchart illustrating a deblocking filtering method according to an example embodiment.

Referring to FIGS. 2, 4, and 5, a macroblock group including at least one macroblock may be set in operation S5 10. For example, a macroblock group including the macroblocks a₁, b₁, c₁, and d₁ may be defined as the first macroblock group MBG_1 and/or a macroblock group adjacent to the first macroblock group MBG_1 in the column direction may be defined as the second macroblock group MBG_2. After n macroblock groups are defined in this way, the n^{th} macroblock group may be positioned in the bottom line of a frame.

First, the first macroblock group MBG_1 may be stored in the internal memory 230. It may not be necessary to perform deblocking filtering on a side (e.g., the left side) of the first macroblock group MBG_1, which is adjacent to the frame. However, deblocking filtering may be performed on boundaries between two adjacent macroblocks of the first macroblock group MBG_1. In other words, deblocking filtering may be performed on a boundary between the macroblocks a₁ and b₁, a boundary between the macroblocks b₁ and c₁, and/or a boundary between the macroblocks c₁ and d₁. After deblocking filtering is completed, the deblocking-filtered first macroblock group MBG_1 may be stored in the external memory 240 in operation S520.

When the second macroblock group MBG_2 is deblocking-filtered after deblocking filtering of the first macroblock group MBG_1, all or substantially all data stored in the internal memory 230, except for reference areas RF_1, RF_2, RF_3, and/or RF_4 of the first macroblock group MBG_1 referred to for deblocking filtering of the second macroblock group MBG_2 in operation S530, may be eliminated from the internal memory 230. The second macroblock group MBG_2 to be deblocking-filtered may be stored in the internal memory 230 in operation S540. Deblocking filtering may be performed on the second macroblock group MBG_2 stored in the internal memory 230 by referring to the reference areas RF_1, RF_2, RF_3, and/or RF_4 of the first macroblock group MBG_1 in operation S550. For example, deblocking filtering may be performed on a boundary between reference area RF_1 of the first macroblock group MBG_1 and adjacent macroblock a₂, a boundary between reference area RF_2 of the first macroblock group MBG_1 and adjacent macroblock b₂, a boundary between reference area RF_3 of the first macroblock group MBG_1 and adjacent macroblock c₂, and/or a boundary between reference area RF_4 of the first macroblock group MBG_1 and adjacent macroblock d₂. After deblocking filtering of the second macroblock group MBG_2 is completed, the deblocking-filtered second macroblock group MBG_2 and/or the reference areas RF_1, RF_2, RF_3, and/or RF_4 of the first macroblock group MBG_1 may be stored in the external memory 240 in operation S560.

The operations described above may be repeated until deblocking filtering of the n^{th} macroblock group MBG_n is completed in operation S570. Once deblocking filtering of the n^{th} macroblock group MBG_n is completed, a macroblock adjacent to the first macroblock group MBG_1 in the row direction (e.g., a macroblock group including the macroblocks e₁, f₁, g₁, and h₁) may be defined as a first macroblock group MGB_1′ and deblocking filtering may be resumed in the first macroblock group MBG_1′ in a manner similar to that described above in operation S590. The operations described above may be repeated until deblocking filtering of the entire frame is completed in operation S580.

FIG. 6 illustrates the structures of a second macroblock group MBG_2′ illustrated in FIG. 4 and reference areas RF_1′, RF_2′, RF_3′, RF_4′, and RF_L referred to for deblocking filtering of the second macroblock group MBG_2′.

The capacity of the internal memory 230 will be described with reference to FIG. 6. The internal memory 230 may require a capacity for storing at least the data illustrated in FIG. 6. In FIG. 6, each of the macroblocks e₂, f₂, g₂, and h₂ may include 16×16 pixels, each of the reference areas RF_1′, RF_2′, RF_3′, and RF_4′ may include 4×16 pixels, and the reference area RF_L may include 16×4 pixels. To perform deblocking filtering on a macroblock (e.g., macroblock e₂), a reference area RF_L located to the left side of the macroblock e₂ and/or a reference area RF_1′ located above the macroblock e₂ may be required. In an example embodiment, the four macroblocks e₂, f₂, g₂, and h₂ may be grouped into a second macroblock group MGB_2′. Thus, the second macroblock group MGB_2′ may be deblocking-filtered with the reference area RF_L located to the left side of the second macroblock group MGB_2′ and/or the reference areas RF_1′, RF_2′, RF_3′, and/or RF_4′ of the first macroblock group MBG_1′ located above the macroblocks of the second macroblock group MGB_2′. For example, deblocking filtering may be performed on a boundary between reference area RF_L of macroblock d₂ (and second macroblock group MBG_2) and adjacent macroblock e2, a boundary between the macroblocks e₂ and f₂, a boundary between the macroblocks f₂ and g₂, and/or a boundary between the macroblocks g₂ and h₂. Additionally or in the alternative, deblocking filtering may be performed on a boundary between reference area RF_1′ of the first macroblock group MBG_1′ and adjacent macroblock e₂, a boundary between reference area RF_2′ of the first macroblock group MBG_1′ and adjacent macroblock f₂, a boundary between reference area RF_3′ of the first macroblock group MBG_1′ and adjacent macroblock g₂, and/or a boundary between reference area RF_4′ of the first macroblock group MBG_1′ and adjacent macroblock h₂.

After the deblocking filtering is completed, all or substantially all data stored in the internal memory 230, except for the reference area or areas for the second macroblock group MGB_2′, may be eliminated from the internal memory 230. Thereafter, once a third macroblock group MGB_3′, a reference area RF_L located to the left side of the third macroblock group MGB_3′, and/or the reference areas RF_1′, RF_2′, RF_3′, and/or RF_4′of the second macroblock group MBG_2′ located above the macroblocks of the third macroblock group MGB_3′ are stored in the internal memory 230, deblocking filtering may be performed on the third macroblock group MGB_3′. Successive macroblock groups may be deblocking-filtered in a similar manner to that discussed above.

For example, it may be assumed that: deblocking filtering may be performed on a frame of 720×480 pixels; a macroblock may include 16×16 pixels; a reference area may include 4×16 pixels or 16×4 pixels; and/or a pixel may include 8 bits. Thus, the frame may have 45×30 macroblocks.

According to the related art, as many as forty-five macroblocks, forty-five 4×16 pixels reference areas, and one 16×4 pixels reference area should be stored in the internal memory at a given time in order to perform deblocking filtering on the frame. In other words, for storing just the reference area or areas, the internal memory should have a capacity of (45+1)×64×8=23,552 bits.

According to example embodiments, if 5 macroblocks are grouped into a macroblock group, it may be necessary to store only five macroblocks, five 4×16 pixels reference areas, and/or one 16×4 pixels reference area in the internal memory 230 at a given time in order to perform deblocking filtering on the frame. In other words, for storing just the reference area or areas, the internal memory may need to have a capacity of only (5+1)×64×8=3,072 bits. In other words, the capacity of the internal memory required by the reference area or areas may be reduced.

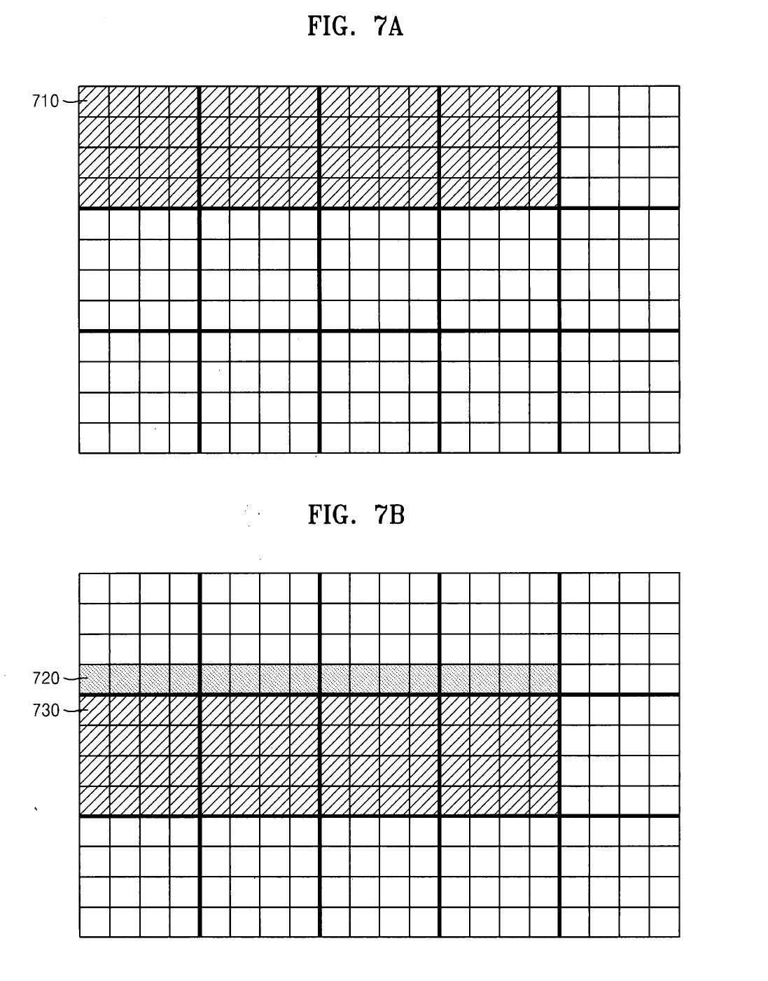

FIGS. 7A and 7B illustrate areas of macroblocks stored in the internal memory 230.

FIG. 7A shows a state in which a first macroblock group MGB_1 710 may be stored in the internal memory 230. Referring to FIG. 7A, the first macroblock group MGB_1 710 may have no reference area or areas located above itself and thus, only the first macroblock group MGB_1 710 may be stored in the internal memory 230.

FIG. 7B shows a state in which an arbitrary macroblock group may be stored in the internal memory 230. Referring to FIG. 7B, the second macroblock group MGB_2 through the n^{th} macroblock group MBG_n may have a reference area 720 located above themselves and thus, each macroblock group 730 and the reference area 720 may be stored in the internal memory 230.

If there is a reference area located to the left side of the macroblock group in FIGS. 7A and 7B, the reference area also may be stored in the internal memory 230.

The example embodiments may be applied to any case where deblocking filtering is performed in MPEG as well as H.264.

As described above, according to the example embodiments, by reducing a reference area or areas stored in an internal memory, deblocking filtering may be performed with an internal memory having a relatively small capacity. Since macroblocks may be deblocking-filtered in macroblock group units, bandwidth required to access external memory may also be reduced.

While example embodiments have been particularly shown and described, it will be understood by those of ordinary skill in the art that various changes in form and details may be made therein without departing from the spirit and scope of the present invention as defined by the following claims.

What is claimed is:

1. A deblocking filtering method, comprising:
setting first through n^{th} macroblock groups which are adjacent to one another in a column direction; and
sequentially performing deblocking filtering on the first through n^{th} macroblock groups;
wherein each macroblock group comprises at least one macroblock.

2. The method of claim 1, further comprising:
storing a macroblock group to be deblocking-filtered in internal memory.

3. The method of claim 2, wherein the storing a macroblock group to be deblocking-filtered in internal memory comprises:
when deblocking filtering is to be performed on a (k+1)^{th} macroblock group after deblocking filtering is performed on a k^{th} macroblock group, eliminating all or substantially all data stored in the internal memory, except for a reference area or areas of the k^{th} macroblock group to be referred to for deblocking filtering of the (k+1)^{th} macroblock group; and
storing the (k+1)^{th} macroblock group in the internal memory;
wherein k is a natural number that is greater than or equal to 1 and less than or equal to (n−1).

4. The method of claim 2, wherein when deblocking filtering is to be performed on a (k+1)^{th} macroblock group after deblocking filtering is performed on a k^{th} macroblock group, the internal memory has a capacity that is greater than or equal to a sum of a size of the (k+1)^{th} macroblock group and a size of a reference area or areas of the k^{th} macroblock group to be referred to for deblocking filtering of the (k+1)^{th} macroblock group, and
wherein k is a natural number that is greater than or equal to 1 and less than or equal to (n−1).

5. The method of claim 1, further comprising:
when deblocking filtering of a (k+1)^{th} macroblock group is completed, storing the deblocking-filtered (k+1)^{th} macroblock group and a reference area or areas of a k^{th} macroblock group referred to for the deblocking filtering of the (k+1)^{th} macroblock group in external memory, and
wherein k is a natural number that is greater than or equal to 1 and less than or equal to (n−1).

6. The method of claim 1, further comprising:
when deblocking filtering on the first macroblock group is completed, storing the deblocking-filtered first macroblock group in external memory.

7. The method of claim 1, wherein the sequentially performing deblocking filtering on the first through n^{th} macroblock groups comprises:
when deblocking filtering on the n^{th} macroblock group is completed, performing deblocking filtering on a macroblock group which is adjacent to the first macroblock group in a row direction.

8. The method of claim 2, further comprising:
when deblocking filtering on the n^{th} macroblock group is completed, eliminating all or substantially all data stored in the internal memory to initialize the internal memory.

9. The method of claim 1, further comprising:
storing a macroblock group to be deblocking-filtered in internal memory; and
storing the deblocking-filtered macroblock group in external memory;
wherein when deblocking filtering is to be performed on a (k+1)^{th} macroblock group after deblocking filtering is performed on a k^{th} macroblock group, the internal memory has a capacity that is greater than or equal to a sum of a size of the (k+1)^{th} macroblock group and a size of a reference area or areas of the k^{th} macroblock group to be referred to for deblocking filtering of the (k+1)^{th} macroblock group, and
wherein k is a natural number that is greater than or equal to 1 and less than or equal to (n−1).

10. The method of claim 9, wherein the storing a macroblock group to be deblocking-filtered in internal memory comprises:
when deblocking filtering is to be performed on the (k+1)^{th} macroblock group after deblocking filtering is performed on the k^{th} macroblock group, eliminating all or substantially all data stored in the internal memory, except for a reference area or areas of the k^{th} macroblock group to be referred to for the deblocking filtering of the (k+1)^{th} macroblock group; and
storing the (k+1)^{th} macroblock group in the internal memory;
wherein k is a natural number that is greater than or equal to 1 and less than or equal to (n−1).

11. The method of claim 9, wherein the storing the deblocking-filtered macroblock group in external memory comprises:
when deblocking filtering of the (k+1)^{th} macroblock group is completed, storing the deblocking-filtered (k+1)^{th} macroblock group and a reference area or areas of the k^{th} macroblock group referred to for the deblocking filtering of the (k+1)^{th} macroblock group in the external memory;
wherein k is a natural number that is greater than or equal to 1 and less than or equal to (n−1).

12. The method of claim 9, further comprising:
when deblocking filtering on the first macroblock group is completed, storing the deblocking-filtered first macroblock group in the external memory.

13. The method of claim 9, wherein the sequentially performing deblocking filtering on the first through n^{th} macroblock groups comprises:
when deblocking filtering on the n^{th} macroblock group is completed, performing deblocking filtering on a macroblock group which is adjacent to the first macroblock group in a row direction.

14. The method of claim 9, further comprising:
when deblocking filtering on the n^{th} macroblock group is completed, eliminating all or substantially all data stored in the internal memory to initialize the internal memory.

15. An image processing device, comprising:
a deblocking filter that performs deblocking filtering in macroblock units; and
a control unit that sets first through n^{th} macroblock groups, which are adjacent to one another in a column direction, and that controls the deblocking filter to sequentially perform deblocking filtering on the first through n^{th} macroblock groups;
wherein each macroblock group comprises at least one macroblock.

16. The device of claim 15, further comprising:
an internal memory storing a macroblock group to be deblocking-filtered.

17. The device of claim 16, wherein when deblocking filtering is to be performed on a (k+1)^{th} macroblock group after deblocking filtering is performed on a k^{th} macroblock group, all or substantially all data stored in the internal memory, except for a reference area or areas of the k^{th} macroblock group to be referred to for deblocking filtering of the (k+1)^{th} macroblock group, is eliminated and the (k+1)^{th} macroblock group is stored in the internal memory, and
wherein k is a natural number that is greater than or equal to 1 and less than or equal to (n−1).

18. The device of claim 16, wherein when deblocking filtering is to be performed on a (k+1)^{th} macroblock group after deblocking filtering is performed on a k^{th} macroblock group, the internal memory has a capacity that is greater than or equal to a sum of a size of the (k+1)^{th} macroblock group and a size of a reference area or areas of the k^{th} macroblock group to be referred to for deblocking filtering of the (k+1)^{th} macroblock group, and
wherein k is a natural number that is greater than or equal to 1 and less than or equal to (n−1).

19. The device of claim 15, further comprising:
an external memory;
wherein when deblocking filtering of a (k+1)^{th} macroblock group is completed, the external memory stores the deblocking-filtered (k+1)^{th} macroblock group and a reference area or areas of a k^{th} macroblock group referred to for the deblocking filtering of the (k+1)^{th} macroblock group, and
wherein k is a natural number that is greater than or equal to 1 and less than or equal to (n−1).

20. The device of claim 19, wherein when deblocking filtering on the first macroblock group is completed, the external memory stores the deblocking-filtered first macroblock group.

21. The device of claim 15, wherein when deblocking filtering on the n^{th} macroblock group is completed, the control unit controls the deblocking filter to perform deblocking filtering on a macroblock group which is adjacent to the first macroblock group in a row direction.

22. The device of claim 16, wherein when deblocking filtering on the n^{th} macroblock group is completed, the internal memory eliminates all or substantially all data stored in the internal memory to initialize the internal memory.

23. The device of claim 15, further comprising:
an internal memory storing a macroblock group to be deblocking-filtered; and
an external memory storing the deblocking-filtered macroblock group;
wherein when deblocking filtering is to be performed on a (k+1)^{th} macroblock group after deblocking filtering is performed on a k^{th} macroblock group, the internal memory has a capacity that is greater than or equal to a sum of a size of the (k+1)^{th} macroblock group and a size of a reference area or areas of the k^{th} macroblock group to be referred to for deblocking filtering of the (k+1)^{th} macroblock group, and
wherein k is a natural number that is greater than or equal to 1 and less than or equal to (n−1).

24. The device of claim 23, wherein when deblocking filtering is to be performed on the (k+1)^{th} macroblock group after deblocking filtering is performed on the k^{th} macroblock group, all or substantially all data stored in the internal memory, except for a reference area or areas of the k^{th} macroblock group to be referred to for deblocking filtering of the (k+1)^{th} macroblock group, is eliminated and the (k+1)^{th} macroblock group is stored in the internal memory, and
wherein k is a natural number that is greater than or equal to 1 and less than or equal to (n−1).

25. The device of claim 23, wherein when deblocking filtering of the (k+1)^{th} macroblock group is completed, the external memory stores the deblocking-filtered (k+1)^{th} macroblock group and a reference area or areas of the k^{th} macroblock group referred to for the deblocking filtering of the (k+1)^{th} macroblock group, and
wherein k is a natural number that is greater than or equal to 1 and less than or equal to (n−1).

26. The device of claim 23, wherein when deblocking filtering on the first macroblock group is completed, the external memory stores the deblocking-filtered first macroblock group.

27. The device of claim 23, wherein when deblocking filtering on the n^{th} macroblock group is completed, the control unit controls the deblocking filter to perform deblocking filtering on a macroblock group which is adjacent to the first macroblock group in a row direction.

28. The device of claim 23, wherein when deblocking filtering on the n^{th} macroblock group is completed, the internal memory eliminates all or substantially all data stored in the internal memory to initialize the internal memory.
